(19) United States
(12) Patent Application Publication
(10) Pub. No.: US 2011/0217430 A1
(43) Pub. Date: Sep. 8, 2011

(54) THERMOPLASTIC AND BIODEGRADABLE POLYMER FOAMS CONTAINING OXYGEN SCAVENGER

(76) Inventors: Chieh-Chun Chau, Victor, NY (US); Samuel A. Incorvia, North Tonawanda, NY (US); David S. Payne, West Seneca, NY (US); Thomas H. Powers, Mayville, NY (US); Stanislav E. Solovyov, Getzville, NY (US)

(21) Appl. No.: 12/719,160

(22) Filed: Mar. 8, 2010

(51) Int. Cl. B65B 55/00; C09K 3/00; A23B 4/00; B65D 81/24

(52) U.S. Cl. 426/118; 252/188.28; 426/395; 206/524.4

(57) ABSTRACT

The invention relates to an oxygen scavenging material comprising an oxygen scavenger disbursed in a low density foam, wherein the oxygen scavenger has a particle size of less than 25 μm. In another embodiment the invention relates to a product package comprising a foam tray, product in the tray, and a polymer cover surrounding the meat and tray, wherein the foam tray comprises an oxygen scavenging material, wherein the oxygen scavenging material comprises an oxygen scavenger disbursed in the foam and wherein the oxygen scavenger has a particle size of less than 25 μm.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The invention relates to an oxygen scavenger material disbursed in a low-density foam. In particular, it relates to the oxygen scavenger material in the form of foam tray for packaging food products.

2. Description of Related Art

Rigid food containers such as meat trays and disposable cups are used broadly in food packaging and services. Conventional trays and containers used in meat or food packaging are usually foamed to reduce the weight yet provide rigidity for packaging and transport. The material is typically polystyrene and other polyolefins.

A desirable feature of the containers is to maintain the freshness of the food. A common method to improve the freshness of a meat package is to remove the excess liquid by using soaking pads. A more effective method is to reduce the oxygen contents inside the package. The effectiveness has been shown by case ready meat packaged with oxygen scavengers.

The case ready meat is packaged at a central packinghouse and then transported in bags containing a plurality of meat packages to the grocery store or restaurant where it is used. The packaged meat normally is in a styrofoam tray and covered with a polymer wrapping that is perforated with small holes to allow gas circulation. The bags normally are formed of an oxygen resistant polymer sheet and contain oxygen scavenger in the form of sheets or sachets containing oxygen scavenger material. It has been found that the foam trays and meat give off oxygen and it is difficult to include enough oxygen scavenger to cost effectively and rapidly absorb all the oxygen.

A known method to absorb oxygen in food packaging is by embedding or extruding the oxygen scavengers in a polymer matrix. The prior art in this area are primarily focused on solid polymer films or sheets although it was known to extrude oxygen scavengers in cellular structures.

The following patents relate to oxygen control in packaging:

U.S. Pat. No. 6,194,042 B I (Tri-Seal Holdings, Inc, 2001) described a multilayer liner that has a foamed core in the layers.

U.S. Pat. No. 4,188,457 (Metal Box Limited, 1980) described a cork closure for wine bottle.

U.S. Pat. No. 4,781,295 (Mobil Oil Co, 1988) described an improved foamed meat tray by blending of polystyrene with polyethylene.

U.S. Pate. No. 6,908,652 B I (Cryovac, 2005) described oxygen scavenger with polylactic acid in the multilayer articles without involving foaming.

U.S. Pat. No. 6,213,294 BI (Tres Fresh LLC, 2001) described a modified atmosphere package using foam trays.

U.S. Pat. No. 6,071,580 (Dow Chemical, 2000) described methods of making open cell foams and trays for fluid absorption application.

There remains a need for an improved method of preparing packages for meat and other produce. There remains a need for better oxygen control in packages of meat that are packaged in a location distant from the sales point.

### BRIEF SUMMARY OF THE INVENTION

The invention relates to an oxygen scavenging material comprising an oxygen scavenger disbursed in a low density foam, wherein the oxygen scavenger has a particle size of less than 25 μm.

In another embodiment the invention relates to a product package comprising a foam tray, the foam tray comprising an oxygen scavenging material, a product in the tray, and a polymer cover surrounding the product and tray, wherein the oxygen scavenging material comprises an oxygen scavenger disbursed in the foam and, wherein the oxygen scavenger has a particle size of less than 25 μm.

### BRIEF DESCRIPTION OF THE SEVERAL VIEWS OF THE DRAWING(S)

FIG. 1 is a cross-section of a foam material in accordance with the invention.

FIG. 2 is a schematic illustration of a cross-section of a product package in accordance with the invention.

FIG. 3 is a schematic cross-section illustration of a master product enclosure with product packages in the enclosure.

FIG. 4 represents an oxygen absorption property of oxygen scavenger polystyrene foams.

FIG. 5 Oxygen shows a comparison of a oxygen scavenger PLA foam comparing with the neat foam for prolonged storage under 92% RH.

### DETAILED DESCRIPTION OF THE INVENTION

The invention has numerous advantages over prior product packaging material and methods of shipping master enclosures of product that is sensitive to deterioration because of the presence of oxygen. The invention reduces the need for loose oxygen scavenger elements in packages. The preferred products of the invention allow activation of oxygen scavenger by the water that is in the product being packaged. The water activated oxygen absorption materials in the foam product tray reduce the need for separate oxygen scavenger in the master enclosure as well as allowing shipment of the empty foam containers without excessive protection from premature oxygen absorption.

The advantages of incorporating active oxygen scavengers in foam containers include extending freshness of meat/food packages, providing additional freshness for case ready meat, activating the scavengers with liquids leaking from the meat/foods, and no or less need of scavenging sachets.

The attributes of the foamed articles of this invention further include the following: (a) uniform dispersion giving good appearance, (b) tuneable oxygen absorption rate through cell size, open cell level and density control, (c) improved expansion ratio or reduced foaming agent to reduce volatile organic compounds (VOC), (d) retained mechanical properties, and (e) printable and decoratable.

These and other advantages will become apparent from the following detailed description and drawings.

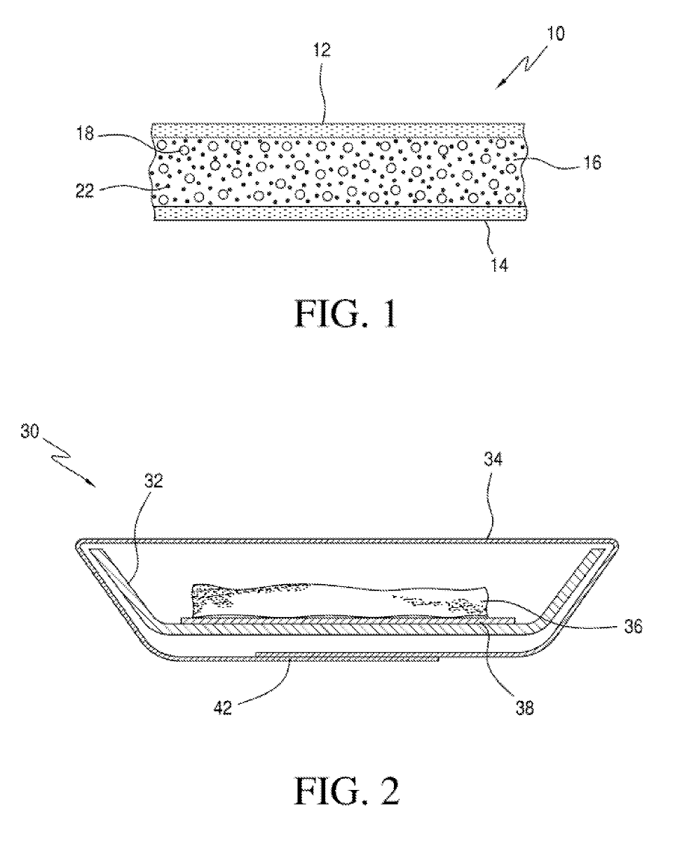

FIG. 1 is a cross-section of an oxygen scavenging material 10. The oxygen scavenger material is provided with skin layers 12 and 14 and a foam core layer 16. The skin layers 12 and 14 and the foam core layer 16 contain oxygen scavengers 22. The foam core layer 16 contains pores 18 as well as oxygen scavenger material 22. It is noted that some of the oxygen scavenger material 22 borders the pores 18 and aided nucleation of the pores 18. The scavenger material as it aids pore formation allowed use of less blowing agents.

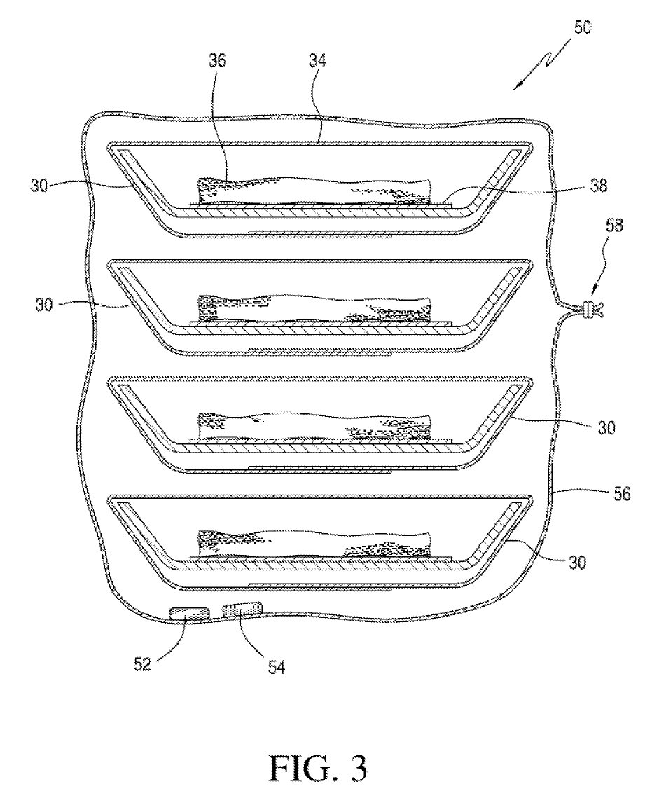

FIG. 2 illustrates a product package 30 formed using the oxygen scavenging material 10 such as illustrated in FIG. 1. The oxygen scavenger material 10 has been formed into a tray 32, by well-known means such as thermoforming, not shown. The tray 32 contains a product, such as beef 36 that contains some moisture, and preferably an absorbent pad 38. The tray 32 has been wrapped with a polymer sheet and sealed at the bottom 42. The polymer wrapping material may be an oxygen barrier material or in some instances it may be microperforated to allow escape of gases from the package. The wrapping would be microporous for master product enclosure shipping. For local and in-store use, the wrapping would not be porous. The absorbent pad 38 is a conventional absorbent pad used in the tray packaging of meat to absorb meat juices.

In FIG. 3 is illustrated a master product enclosure 50. The master product enclosure 50 is illustrated with four product packages 30 that are stacked within the bag 56 that is formed of oxygen barrier polymer sheet. Gases are withdrawn from the bag 56 and the bag 56 is sealed by closure 58. The bag 56 prior to sealing is provided with oxygen scavenger elements 52 and 54. The product packages 30 would be provided with a microporous covering 34 to allow oxygen scavenging both by the oxygen scavenger material in the tray 32 and by the oxygen scavenger elements 52 and 54. Sources of oxygen in the bag 56 are residual air that was not removed, outgassing of oxygen from the meat and outgassing of oxygen from the foam tray 32. The use of the oxygen scavenging elements 52 and 54 may not be necessary if the trays 32 have enough oxygen scavenging capacity.

In this invention, a method is disclosed to make cellular foam sheets that contain oxygen scavengers. The method is by direct extrusion of iron-based oxygen scavenger in the foaming resin to allow uniform dispersion of the active ingredient in the foam matrix. The foam sheets can be thermoformed into containers by using the conventional thermoforming processes. The preferred foaming agents are those of the physical foaming agents such as light hydrocarbons or inert gases that do not contain or generate moisture.

In a preferred embodiment there is provided a thermoplastic polymer foam, with a density reduction of >50% from pure polymer and a density of <31 lb/ft³, that contains iron based oxygen scavengers well dispersed in the structure. The preferred polymer is polystyrene as it is low in cost. The preferred iron based oxygen scavenger is in fine powder format with a mean particle sizes in the range of 1-25 μm precoated or compounded with the activating and oxidation reaction promoters. The iron based oxygen scavenger is compounded as masterbatches and fed or premixed with the foaming resin in the solid state prior to melting. Foaming agents are then injected into the polymer melt. The oxygen scavengers may serve as nucleators for foam cells. The foaming resin and the iron based scavenger optionally contain other additives as nucleating agents to form fine cells.

Another embodiment of the invention provides a biodegradable polymer foam that contains iron based oxygen scavengers well dispersed in the structure. The foam has a density reduction of 30% or higher and density of 43 lb/ft³ or lower. A preferred biodegradable polymer is polylactic acid.

The invention provides in another embodiment thermoplastic polymer foams that can reach low foam density with a reduced amount of foaming agent and with the incorporation of iron based oxygen scavengers, thus reducing the volatile organic compounds evolved. The thermoplastic foam is characterized by a shining reflective appearance formed by the skin formation as the foam sheet leaves the die.

Any suitable oxygen scavenger may be utilized in the invention. Typical of oxygen scavengers are sulfur dioxide, chelates of salicylic acid or a salicylate salt. Suitable oxygen scavenger materials are salts or chelates of metals such as zinc, copper, aluminum and tin. Iron oxygen scavengers are preferred as they are effective and low in cost.

A most preferred oxygen scavenger is reduced iron powder coated with activating and acidifying materials. It preferably has 1-25 μm mean particle size, more preferably I-10 μm mean particle size and most preferably 2-5 μm mean particle size for rapid scavenging and good pore formation. The combination and relative fraction of activating and acidifying components coated onto the iron particles are selected according to the teachings of U.S. Pat. No. 6,899,822, U.S. Patent Application Nos. 2005/0205841 and 2007/0020456, incorporated herein by reference. The coating technique is preferably a dry coating as described in the references above. The current invention is particularly focused on iron-based powders with a mean particle size of I-25 um, where iron particles are pre-coated with activating and oxidation reaction promoter particles to form a homogeneous powder. The foamed sheets or articles produced with the finely dispersed oxygen scavenging particles advantageously possess high reactivity with oxygen. The oxygen scavenging particles disperse well throughout the foam structure.

The preferred polymers for the foam oxygen scavenging materials are polystyrene and styrene-butadiene copolymers because of low cost and the strength of the foam articles that can be formed. Other suitable polymers included styrene-ethylene copolymer, polypropylene, polyethylene, polyurethane and their copolymers or derivatives. A combination of a biodegradable polymer and the above polymers may also be utilized.

The preferred polymer for the optional biodegradable resin disclosed in the invention is polylactic acid (PLA) and its copolymers or derivatives. A preferred derivative is branched PLA or lightly cross-linked PLA because the higher melt strength induced by branching or cross-linking in PLA helps the foamability of the resin and gives lower density foams. Other suitable biodegradable polymers included polyhydroxyalkanoates (PHA) aliphatic co-polyesters, and its common type polymer of poly hydroxy butyrate (PHB), polycaprolactone, thermoplastic starches (TPS), cellulose and other polysaccharides. All can have their crystallinity varied to a broad range to result in various physical properties.

Inorganic or organic additives such as talc, CaCO₃, zinc stearate and commercial antioxidants of low concentration of 0.1-5% may be added to the resin to serve as a nucleator for foam cells. The foaming agents include light hydrocarbons such as isobutane, isopentane, HCFC-142B, 141B. It also includes inert gases such as CO2, N2, Ar or mixtures of these components.

The foaming condition should follow what's known to make low density sheet foams. The foams are typically extruded by using tandem extruders with the foaming agents injected at the molten state of the resins. The extruder and die temperature and pressure should be properly maintained to reach the conditions that are favorable for low density foams. The foam density for polystyrene is preferably <31.5 lb/ft³, more preferably <10 lb/ft3, and most preferably 2-5 lb/ft³. The foam density for polylactic acid is preferably <43 lb/ft³, more preferably <20 lb/ft³, and most preferably 2-10 lb/ft³. The lower densities are preferred as the cost is lower.

The oxygen scavenging material is extruded into foam sheets that have a skin on the surface that is formed by the extrusion die where the die collapses the foam surface to form the skin, and a foamed core. The sheets are thermoplastic and may be formed into containers by thermoforming. The preferred container for use in the invention is a tray such as utilized in meat packaging. However, other shapes may be formed such as cups, bowls and plates. The cups and bowls also may be provided with lids of the thermally formed oxygen scavenging foam material.

It is possible by controlling the foam extrusion process to form a foam material with more open pores near the surface of the foam material. The open pore areas of the foam material will absorb oxygen more rapidly than the closed pores. The closed pore areas provide better strength and strengthen the foam material. The balancing of open pore formation with closed pore formation is carried out by foaming temperature control, additives and resin formulations during extrusion.

There is a particular benefit in utilizing the oxygen scavengers that are water activated. When using oxygen scavengers that are water activated there is less need for expensive oxygen-free storage of the formed foam trays prior to use, although it is preferred to keep them in oxygen and water vapor barrier bags prior to use so that their oxygen absorption capacity will not be diminished.

The master product enclosure was illustrated in FIG. 3 as an oxygen and water vapor barrier polymer bag. Any suitable polymer bag may be utilized if it has barrier properties to passage of oxygen and water vapor. The bag may utilize a metal layer as the barrier or be formed of a polymer that has barrier properties. A preferred material has been found to be a polyvinylidene chloride bag as it has good barrier properties and is strong and low in cost. As an alternative to a bag, a rigid container that is heat sealable and lined with a barrier material, such as a metal film and/or polymer material may be utilized.

The master product enclosure is evacuated of air prior to closing. This minimizes the need for oxygen absorption. However, oxygen is given off by products such as meat and vegetables. Further, the foam trays will contain some oxygen that is given off into the bag. While it is known to place oxygen absorbing elements in the form of sheets or sachets into the bags prior to evacuation there is less or no need for additional oxygen absorbing elements if the foam trays have oxygen absorbing properties. It is particularly effective if the oxygen absorbing properties of the tray are activated by moisture from the meat stored in the tray as oxygen given off by the meat will be absorbed more rapidly by the tray, than if it has to work its way to the sachets in the master product enclosure. The use of the oxygen scavenger, incorporated in the foam trays has been shown to give longer storage times for beef and pork before significant deterioration in quality is detectable.

The product protected from deterioration by the oxygen absorbing material has been illustrated as meat as this is a preferred use with both beef and pork. However, the oxygen absorbing material of the invention also could be utilized in the packaging of prepared foods, vegetable produce, fish, and chicken. In other instances, materials such as tobacco, medicine, fruit, and laboratory samples may be sold or transported in the package and master product enclosure of the invention.

### EXAMPLES

### Parts and Percentages Are by Weight Unless Otherwise Indicated

### Example I

### Extruded Polystyrene Compounds Containing Oxygen Scavenger

An oxygen scavenger package was prepared by coating iron particulates, 4-5 μm mean particle size, with sodium bisulfate and sodium chloride to form a homogeneous coated composite powder having a composition of 80 percent iron, 10 percent sodium bisulfate, and 10 percent sodium chloride. The coated composite powder oxygen scavenger was used for extruding with polystyrene resin (Dow Chemical Styron 666). A twin screw extruder compounding equipment was used for compounding the oxygen scavenger with the resin. The resin pellets were mixed with 0.2 wt % mineral oil (retail pharmacy grade) prior to mixing with the oxygen scavenger. The mixture was then fed in the extruder. The extruder was set at 200° C. for all the heating zones and a die temperature at 190° C. The oxygen scavenger/resin mixture was extruded to result in compounds of 20 oxygen scavenger and 80 polymer by weight and 40/60 weight ratio of oxygen scavenger and polymer. The extruded strands were air cooled prior to pelletizing.

### Example 2

### Extrusion of Oxygen Scavenging Polystyrene foams.

A 1.5″ and 2.5″ single screw tandem extruder system was used for extruding polystyrene sheet foams. The oxygen scavenger and resin compound from Example 1, polystyrene (Dow Styron 685) and talc master batch was batch mixed and fed in the 1.5″ extruder set at 180° C. for all the extruder zones. The talc master batch comprises 40/60 ratio of talc powder and polystyrene. The amounts of oxygen scavenger compound, polystyrene, and talc master batch is given in Table 1. Isobutane was injected near the exit of the 1.5″ extruder that connected to the 2.5″ extruder. A 3.5″ flat sheet die was connected to the exit of the 2.5″ extruder and set at 150° C. to extrude sheet foams.

Foam sheets 3-5 mm thick containing oxygen scavenger compounds were extruded and collected as planks. The foams were silver and reflective without visible agglomeration. The net oxygen scavenger resin compound ranged from 2 to 8 wt %. The density of the foam was measured by water immersion test. Table 1 listed the formulation, process condition and properties of the oxygen scavenging polystyrene foam. As indicated, the density of the oxygen scavenger foam is in the range of 2.8-3.1 lb/ft³, comparable to that of the neat polystyrene foam without oxygen scavenger, and is in line with the density of commercial foam trays. This demonstrated the formation of low density oxygen scavenging foams that are useful for making containers or trays.

TABLE I
Extrusion of Oxygen Scavenger Polystyrene Foam:

| | SR | | Foaming | | | | Expan- | den- |
|---|---|---|---|---|---|---|---|---|
| | Net | talc | agent | | Die T | Die P | sion | sity |
| Resin | % | % | type | pph | C. | psi | ratio | pcf |
| Styron | 0 | 0.5 | isobutene | 7 | 135 | 350 | 20 | 3.12 |
| 685 | | | | | | | | |
| Styron | 2 | 0.5 | isobutene | 8 | 125 | 350 | 20 | 3.12 |
| 685 | | | | | | | | |
| Styron | 4 | 1 | isobutene | 6.5 | 140 | 210 | 21 | 2.97 |
| 685 | | | | | | | | |
| Styron | 8 | 1 | isobutene | 5.2 | 135 | 170 | 22 | 2.84 |
| 685 | | | | | | | | |

Die T = Die Temperature C.°
Die P = Die pressure psi
pph = parts per hundred
SR = Oxygen scavenger resin compound

It is observed that the amount of foaming agent needed to produce the same low density foams was generally decreased with the increase of the oxygen scavenger level. This demonstrated the potential reduction of foaming agent with the use of the iron based oxygen scavenger without sacrificing the foam density.

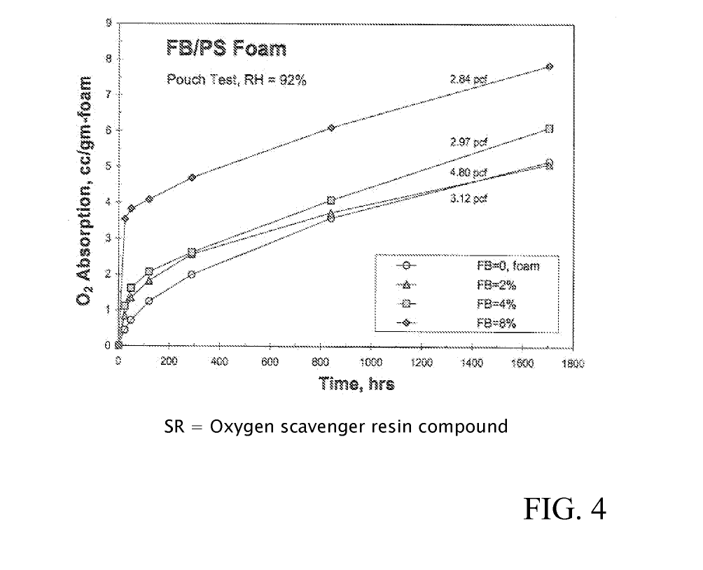

The oxygen scavenging performance was measured by using pouch test. The fresh foam planks were cut and weighed and put in foiled pouches. A humidifying agent that delivers 92% relative humidity was also stored in the pouch to activate the oxygen absorption capability by the oxygen scavenger. The pouch was then sealed and subsequently injected with 300 cc gas from mixture of O₂/N₂=20/80 into the pouch. The oxygen concentration was measured by MOCON Pac Check Model 450 Head Space Analyzer. The oxygen absorption per unit foam weight is shown in FIG. 4 for 2-8 wt % oxygen scavenge resin compound loading. It is noted that since the foam cells contained isobutane with little or no air and moisture in the beginning, the oxygen absorption behavior can be attributed to primarily the surface oxygen scavenger only. The functionality of the oxygen scavenger inside the cellular structure may not have been activated. Nevertheless, the oxygen scavenger foam showed enhanced absorption behavior over the neat foam. If there was more moisture present, the result would have been better as oxygen would have been more rapidly scavenged.

### Example 3

### Extrusion of Oxygen Scavenging PLA Foams

A NatureWork PLA 2002D extruder was used for extruding oxygen scavenger foams. The resin was mixed with the same oxygen scavenger resin compound as in Example 1 v [symbol] oading of 2-4%, and with talc as the nucleator, and isobutane as the foaming agent. The formulation, process condition and properties are listed in Table-3. The foamed sheet has approximately 50% or larger density reduction comparing with the neat resin. Despite relatively weaker formability due to the linear polymer, the PLA foam possesses properties applicable to making foamed sheets for containers and trays. This demonstrated the formation of active cellular PLA produced with iron based oxygen scavenger.

TABLE 3
Extrusion of Oxygen Scavenger PLA Foams:

| | | | | | | | Ex- | |
|---|---|---|---|---|---|---|---|---|
| | SR | | Foaming | | | | pan- | den- |
| | Net | talc | agent | | Die T | Die P | sion | sity |
| Resin | % | % | type | pph | C. | psi | ratio | pcf |
| PLA2002 | 0 | 1 | isobutene | 5 | 120 | 750 | 2.5 | 24.96 |
| PLA2002 | 2 | 1 | isobutene | 7 | 130 | 300 | 2 | 31.20 |
| PLA2002 | 4 | .05 | isobutene | 9 | 130 | 385 | 2.9 | 21.30 |

SR = Oxygen scavenger resin compound

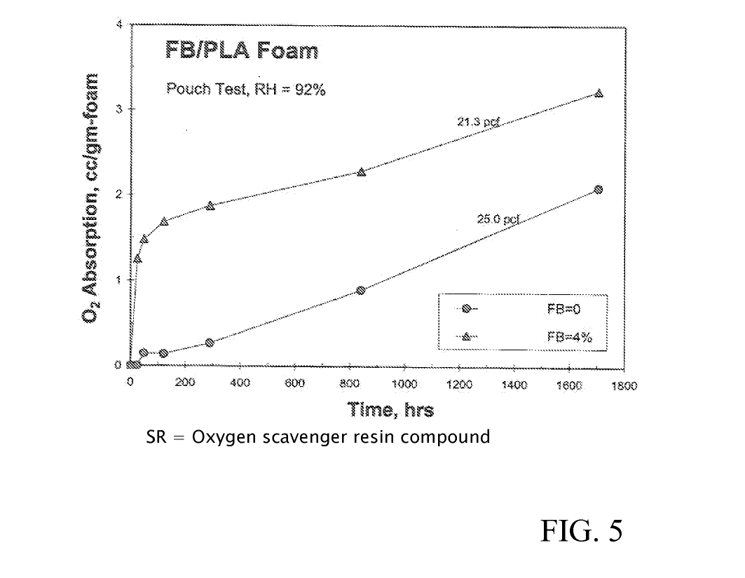

The oxygen absorption behavior of the oxygen scavenger PLA foam samples was measured by using the same method as described, FIG. 5 showed a comparison of a oxygen scavenger PLA foam comparing with the neat foam for prolonged storage under 92% RH. The freshly made foam contains isobutane in the cellular structure and so the neat foam also showed oxygen absorption due to influx of oxygen and exflux of isobutane across the foam cells. The oxygen scavenger PLA foam showed enhanced oxygen absorption comparing with the neat foam.

1. An oxygen scavenging material comprising an oxygen scavenger disbursed in a low-density foam, wherein the oxygen scavenger as a particle size of less than 25 μm.

2. The oxygen scavenging material of claim 1, wherein the foam has a density of less than 31.5 pounds per cubic foot.

3. The oxygen scavenging material of claim 1, wherein the oxygen scavenger comprises iron.

4. The oxygen scavenging material of claim 1, wherein the foam comprises polystyrene polymer.

5. The oxygen scavenging material of claim 1, wherein the material comprises a skin layer.

6. The oxygen scavenging material of claim 5, wherein the material comprises a meat tray.

7. The oxygen scavenging material of claim 1, wherein the oxygen scavenger has a particle size of between 2 and 5 μm.

8. The oxygen scavenging material of claim 1, wherein the low density foam comprises a biodegradable polymer.

9. The oxygen scavenging material of claim 1, wherein the biodegradable low density foam comprises a biodegradable polymer comprising polylactic acid polymer or its derivatives.

10. The oxygen scavenging material of claim 1, wherein the foam has a density of between 15 and 25 pounds per cubic foot.

11. The oxygen scavenging material of claim 1, wherein the foam has a density of between 2 to 15 pounds per cubic foot.

12. A product package comprising a foam tray, product in the tray, and a polymer cover surrounding the product and tray, wherein the foam tray comprises an oxygen scavenging material, the oxygen scavenging material comprises an oxygen scavenger disbursed in the foam and, wherein the oxygen scavenger has a particle size of less than 25 μm.

13. The product package of claim 12, wherein the product is meat.

14. The product package of claim 12, wherein the oxygen scavenger comprises iron.

15. The product of claim 12, wherein the oxygen scavenger comprises iron particles sodium chloride and sodium bisulfate.

16. The product of claim 15, wherein the foam comprises a polystyrene polymer.

17. The product package of claim 13, wherein the meat juices activate the oxygen scavenger.

18. A master product enclosure comprising a container formed of oxygen barrier material, a plurality of product packages comprising a foam tray, product in the tray, a polymer wrap material surrounding each product and tray to form a meat package, wherein the foam tray comprises an oxygen scavenging material disbursed in a foam, wherein the oxygen scavenger has a particle size of less than 25 μm.

19. The master product enclosure of claim 18, wherein the container comprises a bag.

20. The master product enclosure of claim 18, wherein the container comprises a bag comprising polyvinylidene chloride.

21. The master product enclosure of claim 18, wherein the polymer wrap material is perforated.

22. The master product enclosure of claim 18, wherein the product is meat and juices from the meat serve to activate the oxygen scavenger material in the foam.

23. The master product enclosure of claim 18, wherein at least one oxygen scavenger element is in the enclosure.

24. A method for reducing the oxygen concentration in a master product enclosure for a plurality of product packages comprising providing a plurality of product packages, each product package comprising an inactive oxygen scavenger material and a product in contact with the inactive oxygen scavenger material to accelerate oxygen scavenging, providing a master enclosure, and placing the product packages into the master enclosure, purging oxygen from the master enclosure, and sealing the master enclosure, wherein the master enclosure comprises an oxygen impervious layer.

25. The method of claim 24, wherein the inactive oxygen scavenger is activated by juices from the product.

26. The method of claim 24, wherein the oxygen scavenger comprises iron particles coated with hydroscopic material.

27. The method of claim 26, wherein hydroxcopic material is an inorganic salt.

28. The method of claim 20, wherein the master product enclosure comprises an oxygen barrier material.

29. The method of claim 25, wherein the product is meat.
